(19) United States
(12) Patent Application Publication
(10) Pub. No.: US 2025/0100346 A1
(43) Pub. Date: Mar. 27, 2025

(54) SYSTEM FOR SUPPLYING CONDITIONED AIR TO AN AIR INTAKE MANIFOLD OF A VEHICLE

(71) Applicants: Fred Massey, Houston, TX (US); Owen Massey, Round Top, TX (US)

(72) Inventors: Fred Massey, Houston, TX (US); Owen Massey, Round Top, TX (US)

(21) Appl. No.: 18/475,572

(22) Filed: Sep. 27, 2023

(51) Int. Cl. B60H 1/00

(52) U.S. Cl. CPC B60H 1/00849; B60H 1/00564; B60H 2001/00635

(57) ABSTRACT

A system for improving fuel economy of the vehicle has an air conditioning system adapted to supply conditioned air to an interior of the vehicle, an air intake manifold adapted to supply air to an engine of the vehicle, and a hose communicating with the air conditioning system and with the air intake manifold. The hose passes the conditioned air from the air conditioning system to the air intake manifold. A valve is positioned in the hose or connected to the hose so as to cause a unidirectional flow of the conditioned air from the air conditioning system to the air intake manifold. The hose and/or the valve allows a portion of the conditioned air supplied by the air conditioning system to enter the air intake manifold.

### FIELD OF THE INVENTION

The present invention relates to air intake manifolds of vehicles. More particularly, the present invention relates to the delivery of conditioned air into the air intake manifold of the vehicle. Furthermore, the present invention relates to air conditioning systems for supplying conditioned air to a passenger compartment and to an air intake module of a vehicle.

### BACKGROUND OF THE INVENTION

Air intake manifolds are used with virtually all internal combustion engines. The air intake manifold is configured so as to pass ambient air into the combustion chambers of the vehicle. This allows the ambient air to mix with the fuel in each of the cylinders of the vehicle so as to achieve an optimal firing of the cylinders of the vehicle. Typically, air intake manifolds include an inlet that directs air toward the engine. The efficiency of the air intake manifold, along with the efficiency of the internal combustion engine, can be largely dependent upon the quality of supplied air. This quality can relate to the temperature, humidity, density, and other factors affecting the incoming air.

Air conditioning systems are provided in virtually all vehicles. These air conditioning systems serve conditioned air for the passengers within the passenger compartment of the vehicle. The air conditioning systems use a fan motor and a compressor connected to the engine so as to cause the cooling of the air. The operation of the air conditioning system reduces some of the efficiency of the engine. A portion of the power of the engine is required to power the compressor and the mechanisms associated therewith. As such, a loss of efficiency and, hence, fuel economy, occurs whenever the air conditioning system is used.

Charge air coolers are known in the past for reducing the temperature of air inflow to a combustion engine. Charge air cooler heat exchangers are well known in the art for mounting along the flow path of charge air supplied to a combustion engine. This charge air typically comprises ambient air which has been compressed by an apparatus, such as a supercharger or a turbocharger, to provide an increased mass flow of air to the engine to permit the engine to combat increased quantities of fuel and thereby operate at an increased level of power and performance. However, compression of ambient air also elevates the air temperature such that the charge air has a relatively high temperature which, if not reduced, undesirably increases total engine heat load.

In general, the charge air cooler is constructed from a plurality of lightweight heat transfer elements of a heat conductive material, such as copper or aluminum, shaped to provide extended heat transfer surfaces and defining a flow path for the charge air in heat transfer relation with a suitable coolant, such as ambient air or a liquid coolant. More specifically, the charge air cooler may be constructed from a network of fined tubes such that charge air flowing over the fins is associated with a coolant flowing through the tubes resulting in adequate heat transfer for some engine system applications. Alternatively, when improved heat transfer capacity is required, the charge air cooler is constructed from a stack array of plates and fins which cooperate to define a heat exchanger core having separate flow paths for the passage of the charge air and the coolant in close heat transfer relation with each other. In either case, however, the charge air cooler is desirably mounted directly into the intake manifold of the engine wherein charge air passing through the intake manifold is reduced in temperature by flowing through the charge air cooler immediately prior to ingestion by the engine.

The compression of the charge air using the exhaust gases typically leads to a substantial increase in temperature of the air. Such a temperature increase can be undesirable for at least two reasons. First, the density of the air is inversely related to its temperature such that the amount of air mass entering the combustion cylinders in each combustion cycle is lower when the air temperature is elevated, leading to reduced engine output. Second, the production of undesired and/or harmful emissions, such as oxides of nitrogen, increases as the combustion temperature increases. The emissions levels for internal combustion engines is heavily regulated, often making it necessary to control the temperature of the air entering the combustion chambers to a temperature that is relatively close to the ambient air temperature. As such, the cooling of the charge air using charge air coolers has become commonplace for turbocharged engines.

In the past, various patents have issued with respect to providing cooled air to the air intake manifold of vehicles. For example, U.S. Pat. No. 4,474,162, issued on Oct. 2, 1984 to J. L. Mason, describes a charge air cooler mounting arrangement in which a plate-and-fin type heat exchanger is provided with a mounting arrangement for mounting the heat exchanger within the air intake manifold of a combustion engine. A plurality of threaded nuts are secured by welding at predetermined points at the inboard sides of the heat exchanger side plates for receiving bolts passing through aligned bolt-receiving holes in the intake manifold and side plates to secure the heat exchanger in place. This provides a mounting arrangement permitting the heat exchanger to occupy substantially the entire cross-sectional area of the intake manifold for optimized heat transfer capacity.

U.S. Pat. No. 6,314,949, issued on Nov. 13, 2001 to DeGrazia et al., shows a vehicle air induction system that enables an enhanced flow of temperature-controlled, magnetically-influenced forced air to the air intake of internal combustion, turbine-type, and other engines having air intake manifolds. An interior air inlet is positioned in communication with a passenger compartment of the vehicle. An air supply duct extends between the interior air inlet and/or the plenum outlet and the air intake manifold supplies conditioned air. Performance is enhanced by the positioning of magnets into the system. The result of the enhanced flow of magnetically-influenced air improves fuel consumption and air emissions levels.

U.S. Pat. No. 6,941,926, issued on Sep. 13, 2005 the J. A. Fagla, shows an air intake system for an internal combustion engine. The air intake system is attached to the mounting surface of a supercharger or intake manifold such that a plurality of separate air passages of the intake system ensure the uniform distribution of intake air to all parts of the supercharger or intake manifold. Each air passage has a decreasing cross-sectional area along the direction of airflow in order to increase the velocity of the intake air. The air intake system includes a forwardly disposed air inlet, which faces in the direction of travel of the vehicle powered by the engine. The air passages are controlled by butterfly valves in the air inlet.

U.S. Pat. No. 7,178,492, issued on Feb. 20, 2007 to Coleman et al., provides a method of operating an internal combustion engine which includes supplying a mixture of pressurized air and recirculated exhaust gas from an intake manifold to an air intake port of a combustion chamber in the cylinder. An air intake valve is selectively operated to open the air intake port to allow pressurized air to flow between the combustion chamber and the air intake manifold substantially during a majority portion of the compression stroke of the piston. A fuel supply system is operably controlled to inject fuel into the combustion chamber after the intake valve is closed.

U.S. Pat. No. 8,267,073, issued on Sep. 18, 2012 to Kado et al., discloses an air intake apparatus for an internal combustion engine. A housing has an intake passage extending substantially in a vertical direction of the vehicle. A valve is configured to open and close the intake passage. A shaft supports the valve. A bearing supports the shaft. A hose is connected with an upper side of the housing in the vertical direction and configured to lead intake air into the intake passage. A communication passage is configured to communicate from an inside of an internal combustion engine of the vehicle. The communication passage has an opening in the vicinity of a point directly above the bearing.

U.S. Pat. No. 8,695,574, issued on Apr. 15, 2014 to C. D. Nguyen, teaches an intake manifold that includes an integrated charge air cooler and a housing having a first housing part and a second housing part connected thereto. The charge air flows into the house via an inlet and flows out of the housing via an outlet. The charge air cooler is disposed in the housing and is permeated by the charge air on the path from the inlet to the outlet. The charge air cooler is completely enclosed by the housing.

U.S. Pat. No. 9,038,610, issued on May 26, 2015 to Meshenky et al., discloses a charge air cooler and intake manifold. The charge air cooler includes a housing and a heat exchanger core positioned within the housing. The heat exchanger core includes a first core section, a second core section, and a centrally located section positioned between the first core section and the second core section. The charge air cooler includes a plurality of coolant circuits. Each coolant circuit extends through at least one of the first and second core sections. The charge air cooler further includes a coolant inlet extending from the centrally located section to deliver coolant into the plurality of coolant circuits. A coolant outlet extends from the centrally located section to receive coolant from the plurality of coolant circuits.

U.S. Patent Application Publication No. 2010/0071639, published on Mar. 25, 2010 to Wegner et al., shows an apparatus for charge air cooling for an internal combustion engine of a motor vehicle. This apparatus has a first heat exchanger for charge air high-pressure cooling, and at least one second heat exchanger for charge air low-pressure cooling. There is at least one connecting element for connecting the first heat exchanger to the second heat exchanger. A coolant supply conduit supplies the heat exchanger with a coolant. A coolant discharge conduit discharges coolant from one of the heat exchangers.

U.S. Patent Application Publication No. 2012/0167860, published on Jul. 5, 2012 to Wong et al., provides an intake system that includes an integrated airflow cooler module. The cooler module has a lower manifold assembly and a throttle body fluidly connected to and disposed within the lower manifold assembly in order to meter combustion air into the lower manifold volume of the lower manifold assembly. An upper manifold assembly is configured for assembly to the lower manifold assembly in order to define a manifold volume therebetween. The heat exchanger is disposed in the manifold volume between the upper manifold assembly and the lower manifold assembly and between a combustion air inlet and the throttle body.

U.S. Patent No. 2020/0063641, published on Feb. 27, 2022 Tanaka et al., discloses an intake device for a multi-cylinder engine. This intake device includes an intake manifold, an intercooler, and a heat insulation member. The intake manifold has an intercooler housing that is a cylindrical body formed from a resin material and internally accommodates the intercooler. An intake air distributor has one opening connected to one opening of the intercooler housing. An intake air distributor distributes the intake air.

It is an object of the present invention to provide an air intake manifold system that improves fuel economy.

It is another object of the present invention to provide an air intake manifold system which increases engine efficiency.

It is another object of the present invention to provide an air intake manifold system that increases oxygen of less humidity to the engine's air intake.

It is a further out object to the present invention to provide an air intake manifold system that offsets the loss of fuel economy from the drive of the air conditioning compressor.

It is still a further object of the present invention to provide an air intake manifold system that provides denser air to the engine.

These and other objects and advantages of the present invention will become apparent from a reading of the attached specification and appended claims.

### BRIEF SUMMARY OF THE INVENTION

The present invention is a system for improving fuel economy of a vehicle. The system comprises an air conditioning system adapted to supply conditioned air to an interior of the vehicle, an air intake manifold adapted to supply air to an engine of the vehicle, and a hose communicating with the air conditioning system and with the air intake manifold. The air conditioning system has a fan motor and ductwork. The hose passes the conditioned air from the air conditioning system to the air intake manifold.

A valve can be positioned in the hose or connected to the hose so as to cause a unidirectional flow of the conditioned air from the air conditioning system to the air intake manifold. This valve can be in the nature of a butterfly valve positioned in line of the hose. The valve is closed when the air conditioning system is not operating. The valve is open when the air conditioning system is operating. The hose can include a first hose connected to the valve and with the air intake manifold, and a second hose connecting the valve with the air conditioning system. The hose can open to either the fan motor of the air conditioning system or the ductwork of the air conditioning system.

The air intake manifold has an opening formed in the wall thereof. The hole extends into the opening of the air intake manifold. The vehicle has a hole formed in a fender well thereof. The hose extends through this hole in the fender well. A sealant is applied to the opening of the air intake manifold so as to form an air-tight seal between the air intake manifold and the hose. In the preferred embodiment the present invention, the hose is a flex hose formed of a polymeric material.

The present invention is also an apparatus that comprises a vehicle having an air conditioning system adapted to supply conditioned air to a passenger compartment of the vehicle. The air conditioning system has a fan motor and ductwork. The ductwork extends from the fan motor to vents in the passenger compartment of the vehicle. The vehicle has an engine with an air intake manifold. The air intake manifold is adapted to supply air to the engine of the vehicle. A hose communicates with the air conditioning system of the vehicle and extends through the vehicle so as to communicate with the air intake manifold.

The hose passes a portion of the conditioned air from the air conditioning system to the air intake manifold. The air intake manifold has an opening formed through a wall thereof. The hose extends into this opening such that an end of the hose opens to an interior of the air intake manifold.

The fan motor of the air conditioning system has an opening formed therein. The hose has one end secured in the opening of the fan motor is open to an interior of the fan motor. The vehicle has a hole formed in a fender well thereof. The hose extends through the hole of the fender well.

A valve is positioned in the hose or connected to the hose so as to cause a unidirectional flow of the conditioned air from the air conditioning system to the air intake manifold. In the preferred embodiment of the present invention, the valve is a butterfly valve positioned in line of the hose. The valve is closed when the air conditioning system is not operating. The valve is open when the air conditioning system is operating.

It should be noted there approximately 275 to 300 million motor vehicles on American highways. Approximately 95% of these vehicles are equipped with air conditioning systems. The vast majority of these systems are powered by compressor or a pump that derives its energy from the car's engine a belt-driven pulley. The drag on the engine to drive the compressor can consume anywhere from 20 to 25% of the fuel economy from the engine. The present invention utilizes the existing OEM system to help offset the loss of fuel economy when the compressor is engaged. This is accomplished by redirecting a portion of the air supply intended for cabin use back to the intake manifold of the engine. Since the purpose of the air conditioning compressor system is to generate colder and drier air for passengers, this colder and drier air will also allow the engine to perform more efficiently by virtue of the fact that the colder and drier air is more dense and contains more oxygen. This allows more efficient combustion using less fuel.

It is important to note that during colder months of the year, when the heater portion of the air conditioning system is engaged, the compressor is also working to dehumidify the cabin air. This is also advantageous to engine performance and that the humidity which is removed from the ambient air allows for the oxygen density to increase and again improve fuel performance. Initial testing of the present invention has indicated that fuel economy can improve by approximately two miles per gallon on highway testing at average speeds of sixty-five miles per hour under similar conditions.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a diagrammatic illustration of the system of the present invention.

FIG. 2 is a plan view showing the air intake manifold of the present invention.

FIG. 3 is a partially cross-sectional view of a vehicle having the system of the present invention therein.

### DETAILED DESCRIPTION OF THE INVENTION

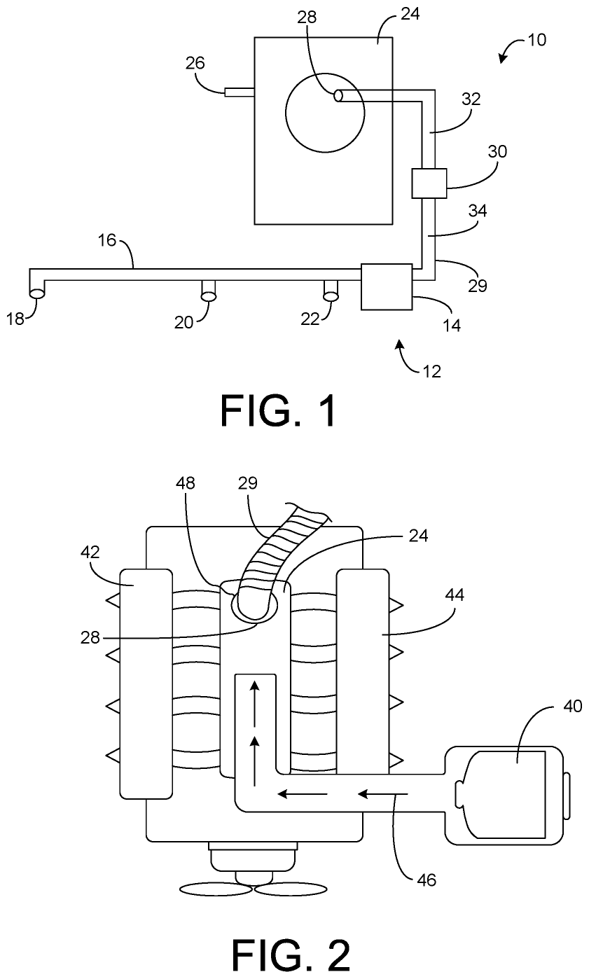

Referring to FIG. 1, there is shown the system 10 for improving fuel economy of a vehicle. System 10 includes an air conditioning system 12 adapted to supply conditioned air to an interior of the vehicle. The air conditioning system has a fan motor 14 and ductwork 16. Ductwork 16 extends from the fan motor 14 to vents 18, 20 and 22. Vents 18, 20 and 22 deliver conditioned air within the passenger compartment of the vehicle. As used herein, the term “air conditioning system” refers to systems that both cool and heat air. As such, the air conditioning system can be interpreted as including conditioned air such as heated air, cooled air, and dehumidified air.

An air intake manifold 24 is configured so as to supply air to the engine 26 of the vehicle. Typically, the air intake manifold 24 will have an opening that allows air to be driven toward the engine 26 as a vehicle travels along a roadway. An opening 28 is formed in the air intake manifold 26. In FIG. 1, it can be seen that there is a hose 29 that extends from the air conditioning system 12 to the air intake manifold 24. In particular, a valve 30 is positioned in the hose 29 or connected to the hose 29 so as to cause a unidirectional flow of the conditioned air from the air conditioning system 12 to the air intake manifold 24. In particular, in FIG. 1, in an embodiment of the present invention, a first hose 32 connects the valve 30 with the air intake manifold 28. A second hose 34 connects the valve 30 with the air conditioning system 12. In particular, hose 29 is illustrated as having one end opening to and connected with the fan motor 14 of the air conditioning system 12.

The valve 30 can be in the nature of a butterfly valve positioned in line of the hose 29. The hose 29 could, in an alternative embodiment, open to the ductwork 16 of the air conditioning system 12. The valve 30 is closed when the air conditioning system 12 is not operating. The valve 30 is open when the air conditioning system 12 is operating. In normal use, valve 30 will be a spring-loaded valve that opens so that a portion of the air from the fan 14 of the air conditioning system 12 enters the second hose 34, flows past the valve 30, enters the second hose 32, and then enters the interior of the air intake manifold 24. The valve 30 prevents any air or pollutants (from the engine) from entering the passenger compartment.

FIG. 2 illustrates the configuration of the air intake manifold 24 of the present invention. It can be seen that the air intake manifold 24 is connected to an air filter 40. The air intake manifold 24 is also directed by lines to the combustion chambers 42 and 44. As can be seen by the arrows 46, air can flow through the air filter 40 so as to enter the air intake manifold 24.

In order to gain the benefits of the present invention, an opening 28 is formed in the air intake manifold 24. Opening 28 has a size suitable for accommodating the outer diameter of the hose 29. This allows air to pass through the hose 29 from the fan motor 14 of the air conditioning system 12 into the interior of the air intake manifold 24. A sealant 48 can be applied around the outer diameter of the hose 29 and around the outer diameter of the opening 28 so as to create an air-tight seal between the outer diameter of the hose 29 and the surfaces of the air intake manifold 24.

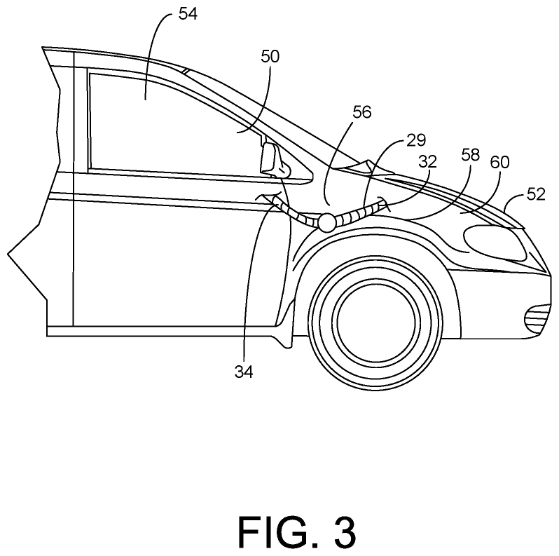

FIG. 3 illustrates the configuration of the hose 29 as it extends through the interior 50 of a vehicle 52. The second hose 34 will extend from the air conditioning system located within the passenger compartment 54 of the vehicle 52. A hole 56 is formed in a fender well 58 of the vehicle 52 so as to allow the hose 29 to pass therethrough. The first hose 32 can then extend through the engine compartment 60 of the vehicle 52 and connect with the air intake manifold 24 (as described herein previously). This construction allows a simple and easy installation of the system of the present invention for the providing of a portion of the conditioned air that enters the passenger compartment 54 of the vehicle 52 to be delivered to the air intake manifold.

The system 10 of the present invention uses existing OEM technology to help offset the loss of fuel economy when the compressor of the air conditioning system 12 is engaged. This is accomplished by redirecting a portion of the air supply intended for use in the passenger compartment 54 of the vehicle 52 back to the intake manifold 24 of the engine 26. The purpose of the air conditioning compressor system is to generate cooer and drier air for passengers. However, this cooler and drier air also allows the engine to perform more efficiently by virtue of the fact that the cooler and drier air is more dense and contains more oxygen. This allows for more efficient combustion using less fuel. During the cooler months of the year, when the heater portion of the air conditioning system is engaged, the compressor also works to dehumidifier the cabin air. This is also advantageous to engine performance in that the humidity (which is removed from the ambient air) allows for the oxygen density to increase and, once again, improves fuel performance.

Initial testing of the system 10 of the present invention has indicated that fuel economy improves by approximately two miles per gallon at highways speeds of sixty miles per hour. As such, the present invention offers a significant advantage over prior art systems.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

We claim:

1. A system for improving fuel economy of a vehicle, the system comprising:
an air conditioning system adapted to supply conditioned air to an interior of the vehicle, said air conditioning system having a fan motor and ductwork;
an air intake manifold adapted to supply air to an engine of the vehicle; and
a hose communicating with said air conditioning system and with said air intake manifold, said hose passing the conditioned air from said air conditioning system to said air intake manifold.

2. The system of claim 1, further comprising:
a valve positioned in said hose or connected to said hose so as to cause a unidirectional flow of the conditioned air from said AC system to said air intake manifold.

3. The system of claim 2, said valve being a butterfly valve positioned in line of said hose.

4. The system of claim 2, wherein said valve is closed when said air conditioning system is not operating, said valve being open when said air conditioning system is operating.

5. The system of claim 2, said hose comprising:
a first hose connecting said valve with said air intake manifold; and
a second hose connecting said valve with said air conditioning system.

6. The system of claim 1, wherein said hose opens to the fan motor of said air conditioning system.

7. The system of claim 1, wherein said hose opens to the ductwork of said air conditioning system.

8. The system of claim 1, said air intake manifold having an opening formed in a wall thereof, said hose extending into the opening of said air intake manifold.

9. The system of claim 1, wherein the vehicle has a hole formed in a fender well thereof, said hose extending through the hole in the fender well.

10. The system of claim 1, wherein the opening of said air intake manifold has a sealant applied thereto so as to form an air-tight seal between said air intake manifold and said hose.

11. The system of claim 1, wherein said hose is a flex hose formed of a polymeric material.

12. An apparatus comprising:
a vehicle having an air conditioning system adapted to supply conditioned air to a passenger compartment of the vehicle, the air conditioning system having a fan motor and the ductwork, the ductwork extending from the fan motor to vents in the passenger compartment of said vehicle, said vehicle having an engine with an air intake manifold, the air intake manifold adapted to supply air to the engine of said vehicle; and
a hose communicating with the air conditioning system of said vehicle and extending through an interior of said vehicle so as to communicate with the air intake manifold.

13. The apparatus of claim 12, said hose passing a portion of the conditioned air from the air conditioning system to the air intake manifold.

14. The apparatus of claim 12, said air intake manifold having an opening formed in a wall thereof, said hose extending into the opening such that an end of the said hose opens to an interior of said air intake manifold.

15. The apparatus of claim 12, wherein the fan motor of said air conditioning system has an opening formed therein, said hose having one end secured in the opening of the fan motor so as to open to an interior of the fan motor.

16. The apparatus of claim 12, wherein said vehicle has a hole formed in a fender well thereof, said hole extending through the hole of the fender well.

17. The apparatus of claim 12, further comprising:
a valve positioned in said hose or connected to said hose so as to cause a unidirectional flow of the conditioned air from said air conditioning system to said air intake manifold.

18. The apparatus of claim 17, wherein said valve is a butterfly valve positioned in line of said hose.

19. The apparatus of claim 18, wherein said valve is closed when said air conditioning system is not operating, said valve being open when said air conditioning system is operating.

20. The apparatus of claim 17, said hose comprising:
a first hose connecting said valve with said air intake manifold; and
a second hose connecting said valve with said air conditioning manifold.
